(19) United States
(12) Patent Application Publication
(10) Pub. No.: US 2015/0027942 A1
(43) Pub. Date: Jan. 29, 2015

(54) COALESCER ASSEMBLIES AND APPLICATIONS THEREOF

(71) Applicant: Kaydon Custom Filtration, LaGrange, GA (US)

(72) Inventors: Ruijun Chen, Auburn, AL (US); Karie Garner, LaGrange, GA (US); Tim Mills, LaGrange, GA (US)

(21) Appl. No.: 14/340,934

(22) Filed: Jul. 25, 2014

Related U.S. Application Data
(60) Provisional application No. 61/858,469, filed on Jul. 25, 2013.

(51) Int. Cl. B01D 29/58; B01D 17/02; B01D 29/23

(52) U.S. Cl. CPC B01D 29/58; B01D 29/232; B01D 17/02
USPC 210/323.2

(57) ABSTRACT

In one aspect, assemblies for removing water from hydrocarbon liquids are described herein. An assembly described herein comprises a coalescer element having interior and exterior surfaces and comprising a porous support tube and a medium positioned within the porous support tube, the medium having a structure for coalescing water droplets in the hydrocarbon liquid passing though the medium. A separation medium encloses the exterior surface of the coalescer element and is spaced apart from the exterior surface of the coalescer element. The separation medium comprises a barrier region for collecting coalesced water droplets in the hydrocarbon liquid exited from the coalescer element and a release region for releasing coalesced water droplets from the assembly.

### RELATED APPLICATION DATA

The present application claims priority pursuant to 35 U.S.C. §119(e) to U.S. Provisional Patent Application Ser. No. 61/858,469 filed Jul. 25, 2013 which is incorporated herein by reference in its entirety.

### FIELD

The present invention relates to apparatus for removing water from hydrocarbon liquids and, in particular, to coalescer elements integrating water separation media.

### BACKGROUND

Filtering and coalescing systems for hydrocarbon industrial fluids, including petrochemicals such as gasoline, diesel fuel, turbine oil, gear oil, hydraulic fluid, lubricating oil, etc., organic and/or vegetable oils, fuels as well as synthetic based lubricants and the like, are well known in the art. Particulate and water contaminants and other foreign substances must be removed from these industrial fluids to ensure proper long term operation and protection of the associated equipment. For example, to achieve long term, predictable and profitable performance from turbines and turbine driven equipment, the lubricant must be both water-free and particulate-free. Oil conditioning systems are used in preventing lubricant oxidation and viscosity breakdown which set the stage for equipment failure due primarily to metal to metal contact between moving parts of the machinery. Preferably, oil conditioning systems quickly and efficiently remove harmful water, particulate and other contaminates from turbine lubrication oils, and other hydrocarbon industrial fluids.

Oil conditioning systems generally have complicated design and construction, often occupying significant space in industrial facilities. Current oil conditioning systems employ a number of individual coalescing elements and downstream separator elements for efficient removal of water and particulate species. The requirement of both individual coalescer elements and separator elements increases design complexity and space requirements for the system. Further, coalescer and separator elements contribute significantly to the initial filtration system cost and subsequent maintenance of oil conditioning systems.

### SUMMARY

In one aspect, assemblies for removing water from organic fluids are described herein. In some embodiments, assemblies described herein address one or more disadvantages of prior organic fluid conditioning systems, including disadvantages precipitated by requisite use of independent coalescer and separator elements.

An assembly described herein for removing water from an organic fluid comprises a coalescer element having interior and exterior surfaces and comprising a porous support tube and a medium positioned within the porous support tube, the medium having a structure for coalescing water droplets in the hydrocarbon liquid passing though the medium. A separation medium encloses the exterior surface of the coalescer element and is spaced apart from the exterior surface of the coalescer element. The separation medium comprises a barrier region for collecting coalesced water droplets in the organic fluid exited from the coalescer element and a release region for releasing coalesced water droplets from the assembly.

In another aspect, organic fluid conditioning apparatus are described herein. An organic fluid conditioning apparatus comprises a coalescing unit having a housing and a plurality of assemblies for removing water from the organic fluid within the housing, wherein at least one of the assemblies includes a coalescer element having interior and exterior surfaces and comprising a porous support tube and a medium positioned within the porous support tube, the medium having a structure for coalescing water droplets in the organic fluid passing through the medium. A separation medium encloses the exterior surface of the coalescer element and is spaced apart from the exterior surface of the coalescer element, the separation medium comprising a barrier region for collecting coalesced water droplets in the organic fluid exited from the coalescer element and a release region for releasing coalesced water droplets from the assembly. Further, in some embodiments, the organic fluid conditioning apparatus does not include one or more separator elements.

In a further aspect, methods of removing water from an organic fluid are described herein. A method of removing water from an organic fluid comprises providing an assembly including a coalescer element having interior and exterior surfaces and comprising a porous support tube and a medium positioned within the porous support tube, the medium having a structure for coalescing water droplets in the hydrocarbon liquid passing through the medium and a separation medium enclosing the exterior surface of the coalescer element and spaced apart from the exterior surface of the coalescer element. The organic fluid is flowed into the interior of the coalescer element and passed through the medium to coalesce water droplets in the organic fluid. The coalesced water droplets in the organic fluid exited from the coalescer element are collected in a barrier region of the separation medium and released from the assembly through a release region in the separation medium. As described further herein, assemblies employing separation media surrounding exterior surfaces of coalescer elements can obviate the use of downstream separator elements in presently available oil conditioning systems.

A variety of organic fluids can be conditioned with coalescer elements, apparatus and methods described herein. In some embodiments, for example, organic fluids comprise hydrocarbon liquids and gases, industrial organic fluids and hydraulic fluids.

In another aspect, assemblies for removing organic fluids from water are described herein. For example, an assembly comprises a coalescer element having interior and exterior surfaces and comprising a porous support tube and a medium positioned within the porous support tube, the medium having a structure for coalescing organic fluid droplets in the water passing though the medium. A separation medium encloses the exterior surface of the coalescer element and is spaced apart from the exterior surface of the coalescer element. The separation medium comprises a barrier region for collecting coalesced organic fluid droplets in the water exited from the coalescer element and a release region for releasing organic fluid droplets from the assembly.

Additionally, water conditioning apparatus are also described herein. A water conditioning apparatus comprises a coalescing unit having a housing and a plurality of assemblies for removing organic fluid from the water within the housing, wherein at least one of the assemblies includes a coalescer element having interior and exterior surfaces and comprising a porous support tube and a medium positioned within the porous support tube, the medium having a structure for coalescing organic fluid droplets in the water passing through the medium. A separation medium encloses the exterior surface of the coalescer element and is spaced apart from the exterior surface of the coalescer element, the separation medium comprising a barrier region for collecting coalesced organic fluid droplets in the water exited from the coalescer element and a release region for releasing coalesced organic fluid droplets from the assembly. Further, in some embodiments, the water conditioning apparatus does not include one or more separator elements.

In a further aspect, methods of removing organic fluid from water are described herein. A method of removing organic fluid from water comprises providing an assembly including a coalescer element having interior and exterior surfaces and comprising a porous support tube and a medium positioned within the porous support tube, the medium having a structure for coalescing organic fluid droplets in the water passing through the medium and a separation medium enclosing the exterior surface of the coalescer element and spaced apart from the exterior surface of the coalescer element. The water is flowed into the interior of the coalescer element and passed through the medium to coalesce organic fluid droplets in the water. The organic fluid droplets in the water exited from the coalescer element are collected in a barrier region of the separation medium and released from the assembly through a release region in the separation medium.

A variety of organic fluids can be removed from water with coalescer elements, apparatus and methods described herein. In some embodiments, for example, organic fluids comprise hydrocarbon liquids including oils, fuels, petroleum products, industrial fluids and hydraulic fluids.

These and other embodiments are described in greater detail in the detailed description which follows.

### BRIEF DESCRIPTION OF THE DRAWINGS

FIG. 1 is a schematic cross-section of an assembly according to one embodiment described herein.

FIG. 2 is an elevational view of an organic fluid conditioning apparatus in which assemblies described herein may be employed.

FIG. 3 is a top plan view of the apparatus of FIG. 2.

FIG. 4 is a perspective view of an open housing of an organic fluid conditioning apparatus containing assemblies described herein and separator elements.

FIG. 5 illustrates an apparatus for water removal testing of assemblies described herein.

FIG. 6 provides water removal test results for an assembly according to one embodiment described herein.

FIG. 7 provides water removal test results for an assembly according to one embodiment described herein.

FIG. 8 provides water removal test results for an assembly according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention, Numerous modifications and adaptations will be readily apparent to those of skill in the art without departing from the spirit and scope of the invention.

I. Assemblies for Water Removal from Organic Fluids

An assembly described herein for removing water from an organic fluid comprises a coalescer element having interior and exterior surfaces and comprising a porous support tube and a medium positioned within the porous support tube, the medium having a structure for coalescing water droplets in the organic fluid passing though the medium. A separation medium encloses the exterior surface of the coalescer element and is spaced apart from the exterior surface of the coalescer element. The separation medium comprises a barrier region for collecting coalesced water droplets in the organic fluid exited from the coalescer element and a release region for releasing coalesced water droplets from the assembly.

Turning now to specific components, an assembly described herein comprises a porous support tube having interior and exterior surfaces. The porous support tube can be constructed of any suitable material not inconsistent with the objectives of the present invention. For example, the porous support tube is constructed of a material of sufficient rigidity to support the coalescing medium positioned within the support tube. In some embodiments, the porous support tube is constructed of metal, such as aluminum. Alternatively, the porous support tube can be constructed of a polymeric material operable for use with organic fluids. In addition to rigidity, the porous support tube has openings or perforations in the sidewall permitting flow of organic fluid therethrough. Design, size and arrangement of the sidewall perforations can be varied according to several factors including flow rate of organic fluid through the assembly and viscosity and/or phase of the organic fluid. As described further herein, organic fluids include organic liquids and organic gases. Furthermore, at least the exterior surface of the porous support tube can be highly hydrophilic by approach of physical and/or chemical surface treatment.

As described further herein, the coalescer element of the assembly can comprise a single porous support tube or multiple porous support tubes. For example, the coalescer element can employ multiple coalescing and/or filtration media requiring use of at least two porous support tubes. In such embodiments, the porous support tubes and associated coalescing media are arranged in a concentric format, wherein an inner support tube supports and inner coalescing medium and an outer support tube supports an outer coalescing medium.

A coalescing medium positioned in a support tube of the assembly can have any structure and arrangement not inconsistent with the objectives of the present invention. For example, a coalescing medium in a support tube is provided as a multilayer pleat block. In some embodiments, a multilayer pleat block can demonstrate preliminary particle filtration functionality in addition to coalescing water droplets in the hydrocarbon liquid passing through the medium. A multilayer pleat block includes individual pleats arranged side-by-side and formed of an integrated, multilayer material.

The compositional identity, number and function of the individual layers of a pleat block can vary depending on the desired properties of the multilayer pleat block. Individual layers of a multilayer pleat block can be formed of fibrous coalescing media, including microglass media, glass fiber media, synthetic fiber media and woven synthetic fiber media. An individual layer of microglass media can have a basis weight of 0.015-0.030 pounds/ft² and a thickness of 10-30 mils. The layer of microglass media can be configured from non-woven glass fibers having a diameter sized to filter particles from the incoming organic fluid and commence water coalescence in the same. Similarly, an individual layer of synthetic fiber media can be configured from non-woven synthetic fibers having a diameter sized to filter particles from the incoming organic fluid and commence water coalescence in the same. An individual layer of synthetic fibers can have a basis weight in the range of 0.020-0.035 pounds/ft² and a thickness of 20-35 mils. Further, an individual layer of glass fiber can have a basis weight in the range of 0.010-0.030 pounds/ft² and a thickness of 10-30 mils. In some embodiments, a glass fiber layer is formed of non-woven glass fibers having a diameter in the range of 0.03-0.06 mils functioning to continue water coalescence in the incoming organic fluid. A multilayer pleat block can also include a layer of woven hydrophilic fabric. In one embodiment, for example, a layer of woven hydrophilic fabric is formed of polyester fibers having hydrophilic surface treatment, the woven hydrophilic fabric demonstrating a mesh opening size of 10-50 μm and an open area of 5-30%.

A multilayer pleat block can employ one or more wire mesh screens as supporting layer(s). In some embodiments, a wire mesh support layer can have a thickness of 5-20 mils and be formed of epoxy coated metal wire, such as epoxy coated steel wire. Wires of a mesh support layer can have diameter of 5-30 mils. In some embodiments, for example, individual fiber layers of the multilayer pleat block are arranged or sandwiched between wire mesh screens. A pleat block can be provided by integrating the individual layers into a single strip and pleating the multilayer strip to integrally join the individual layers. The pleated multilayer strip can be subsequently cut to a predetermined length and formed into a predetermined shape having dimensions for close reception in the interior of the porous support tube. Ends of the strip of pleated material can be joined together to provide a closed structure in the porous support tube.

In addition to the coalescer element, an assembly described herein comprises a separation medium enclosing the exterior surface of the coalescer element and spaced apart from the exterior surface of the coalescer element, the separation medium comprising a barrier region for collecting coalesced water droplets in the organic fluid exited from the coalescer element and a release region for releasing water droplets from the assembly. The separation medium can have any structural and compositional parameters for collecting coalesced water droplets in the organic fluid exited from the coalescer element and releasing the water droplets from the assembly. The barrier region of a separation medium, for example, can comprise a hydrophobic fabric or polymeric membrane. A hydrophobic fabric, in some embodiments, is formed of synthetic fibers. Suitable synthetic fibers can comprise hydrophobic fibers or hydrophilic fibers having a surface treatment rendering the hydrophilic fibers sufficiently hydrophobic for collection of coalesced water droplets. In some embodiments, a hydrophobic fabric is formed of polyimide fiber with hydrophobic surface treatment. Hydrophobic fabric of the barrier region can be woven demonstrating an open mesh size of 10-100 μm and an open area of 5 to 40%. Woven hydrophobic fabric of the barrier region can have a thickness of 40-100 μm and a basis weight of 0.005 to 0.015 pounds/ft². In some embodiments, hydrophobic cloth of the barrier region is commercially available from SaatiTech of Somers, N.Y.

The release region of the separation medium can have any structural and compositional parameters for releasing water droplets collected by the barrier region. In some embodiments, the release region comprises the hydrophobic fabric of the barrier region, wherein the hydrophobic fabric has been provided apertures or perforations of sufficient size to release the collected water droplets from the assembly. A perforation in the hydrophobic fabric, for example, can have a size of 1-5 mm. Alternatively, the release region is formed of hydrophilic fibers for passing collected water droplets out of the assembly. In some embodiments, hydrophilic fibers are provided as a woven hydrophilic fabric. Structural properties of a release hydrophilic fabric can be similar to those of the barrier region hydrophobic fabric regarding open mesh size, open area, thickness and basis weight. Hydrophilic fibers of the fabric can comprise natural or synthetic hydrophilic fibers. In some embodiments, hydrophilic fibers comprise hydrophobic fibers having a surface treatment rendering the fibers sufficiently hydrophilic for the passage of coalesced water droplets out of the assembly. For example, a hydrophilic fabric can be formed of the hydrophobic fabric of the barrier region, wherein the hydrophobic fabric has been provided a surface treatment rendering the fabric hydrophilic.

In some embodiments, hydrophilic fabric of the release region and hydrophobic fabric of the barrier region are seamed together to form the separation medium. In another embodiment, a hydrophobic fabric can be masked, wherein unmasked area of the fabric is provided a hydrophilic surface treatment thereby establishing a release region of the separation medium. Further, the barrier and release regions can occupy varying amounts of surface area of the separation medium. For example, a ratio of surface area of barrier region to release region of the separation medium can range from 500:1 to 1:1. Additionally, the release region can be located proximate one or both ends of the coalescer element for facile removal of water from the assembly.

The separation medium is spaced apart from the exterior surface of the coalescer element providing a space for the water droplets exiting from the coalescer element to further coalesce among each other and simultaneously move downward to the release region. Coalesced water droplets in the organic fluid exited from the coalescer element are blocked by the barrier region of the separation medium as the organic liquid flows through the separation medium. Very small blocked water droplets can attach to the inner surface of the separation medium. These attached droplets merge with water droplets in the incoming organic fluid by droplet collision and release from the attachment sites when sufficient size of the coalesced water droplet is attained. Gravity draws the large blocked water droplets downward in the space between the separation medium and coalescer element. Furthermore, the large blocked droplets wet and reflow over the exterior surface of the coalescer element during their downward motion and coalesce among each other into relatively larger droplets. Gravity draws those enlarged water droplets to the release region for removal from the assembly. Spacing of the separation medium from the exterior surface of the coalescer element can be set according to several considerations, including flow rate of the organic fluid through the assembly, water content of the organic fluid at the inlet of the assembly and viscosity and/or phase of the organic fluid. In some embodiments, the separation medium is spaced from the exterior surface of the coalescer element a distance of 1-50 mm.

In being spaced apart from the exterior surface of the coalescer element, the separation medium can be coupled to the coalescer element through end caps of the coalescer element. For example, hydrophobic and hydrophilic fabric of the separation medium can be coupled to, tucked under or otherwise held in place by end caps. Securing the fabric of the separation medium with end caps of the coalescer element permits the fabric to be spaced apart from the circumferential/sidewall exterior surface of the coalescer element from which the hydrocarbon liquid flows during operation of the assembly.

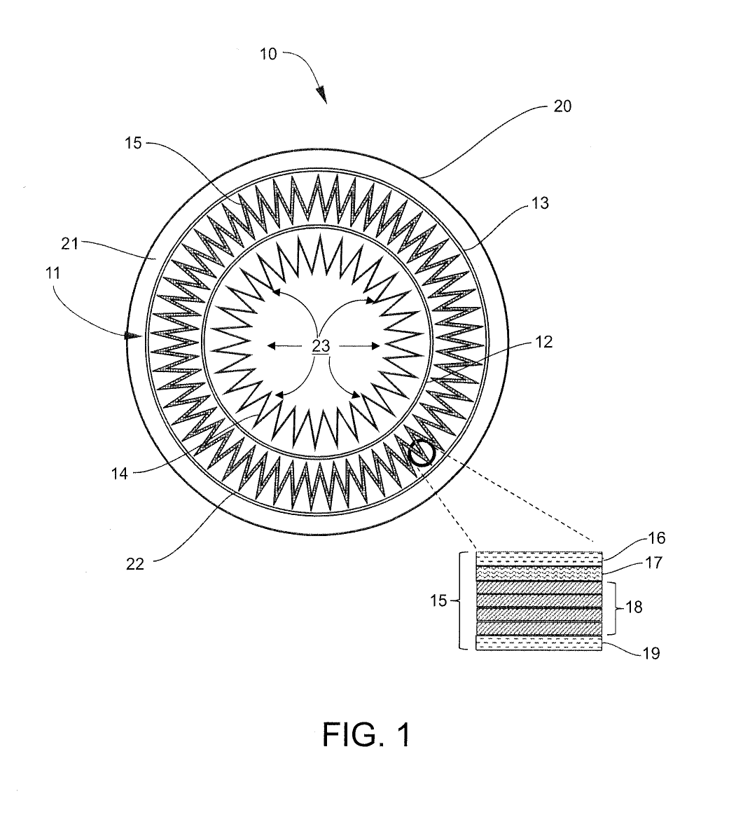

FIG. 1 is a schematic cross-section of an assembly according to one embodiment described herein. As illustrated in FIG. 1, the assembly (10) comprises a coalescer element (11) having an inner porous support tube (12) and an outer porous support tube (13). The inner porous support tube (12) is employed to support a first multilayer pleat block (14), and the outer porous support tube (13) is employed to support a second multilayer pleat block (15). The inner support tube (12)/first pleat block (14) and outer support tube (13)/second pleat block (15) are arranged in a concentric format. The second pleat block (15) demonstrates construction from the interior to the exterior beginning with a support layer (16) of epoxy coated steel wire mesh. The interior support layer (16) is followed by a microglass media layer (17). A plurality of glass fiber layers (18) is located on the downstream side of the microglass media layer (17), and a second support layer (19) of epoxy coated steel wire mesh completes the pleat block construction. In some embodiments, the first multilayer pleat block (14) demonstrates a substantially identical construction to the second multilayer pleat block (15). In other embodiments, the first multilayer pleat block (14) has different construction than the second multilayer pleat block (15) because of the design feature of both preliminary solid particle filtration and water dispersion coalescence.

A separation medium (20) having a construction described herein surrounds the exterior surface (22) of the coalescer element, the separation medium comprising a barrier region for collecting coalesced water droplets in the organic fluid (23) exited from the coalescer element (11) and a release region for releasing coalesced water droplets from the assembly (10). The separation medium (20) is spaced apart from the exterior surface (22) of the coalescer element (11) providing a space (21) for collected water droplets in the barrier region to further coalesce among each other and simultaneously move downward to the release region.

During operation of the assembly (10), organic fluid (23) is introduced into the interior of the coalescer element (11) and passes through the first pleat block (14) where particulate matter is removed and contaminant water in the organic fluid (23) begins coalescing into larger water droplets. The organic fluid (23) and associated water droplets exit the first pleat block (14) passing through the inner porous support tube (12). The organic fluid (23) and water droplets flow into to the second pleat block (15) where further particle filtration and water coalescing occurs. The organic fluid (23) and coalesced water droplets in the organic fluid (23) exit the second pleat block and coalescer element (11) by flowing through the outer porous support tube (13) and into the spacing (21) between the exterior surface (22) of the coalescer element (11) and the separation medium (20). The coalesced water droplets in the organic fluid (23) are collected by the barrier region of the separation medium (20) surrounding the exterior surface (22) of the coalescer element (11) as the organic fluid (23) passes through barrier region of the separation medium (20). The collected water droplets can reflow over the exterior surface (22) of the coalescer element (11) and coalesce among each other into relatively larger droplets. Those enlarged water droplets are removed from the assembly (10) through the water release region of the separation medium (20). For example, gravity can pull the coalesced water droplets to the base of the assembly (10) where the release region of the separation medium (20) is located for removal of the droplets from the assembly (10).

The assembly of FIG. 1 illustrates a double pleat block construction. As described herein, an assembly can also demonstrate a single pleat block construction of the coalescer element in conjunction with the surrounding separation medium.

Organic fluid used in connection with an assembly described herein can comprise any organic fluid not inconsistent with the objectives of the present invention. Organic fluids, for example, can include various hydrocarbon liquids such as fuels, diesel fuels, biofuels, lubricating oil, insulating oil such as transformer oil, synthetic oil and hydraulic fluid. In some embodiments, organic fluids include phosphate ester fluids, such as those employed as hydraulic fluids. Organic fluids can also comprise gases, such as natural gas and/or other hydrocarbon gases.

### II. Organic Fluid Conditioning Apparatus

In another aspect, organic fluid conditioning apparatus are described herein. An organic fluid conditioning apparatus comprises a coalescing unit having a housing and a plurality of assemblies for removing water from the organic fluid within the housing, wherein at least one of the assemblies includes a coalescer element having interior and exterior surfaces and comprising a porous support tube having interior and a medium positioned within the porous support tube, the medium having a structure for coalescing water droplets in the organic fluid passing through the medium. A separation medium encloses the exterior surface of the coalescer element and is spaced apart from the exterior surface of the coalescer element, the separation medium comprising a barrier region for collecting coalesced water droplets in the organic fluid exited from the coalescer element and a release region for releasing coalesced water droplets from the assembly. Assemblies for removing water from the organic fluid can have any construction and/or properties described in Section I herein. Further, in some embodiments, the organic fluid conditioning apparatus does not include one or more separator elements.

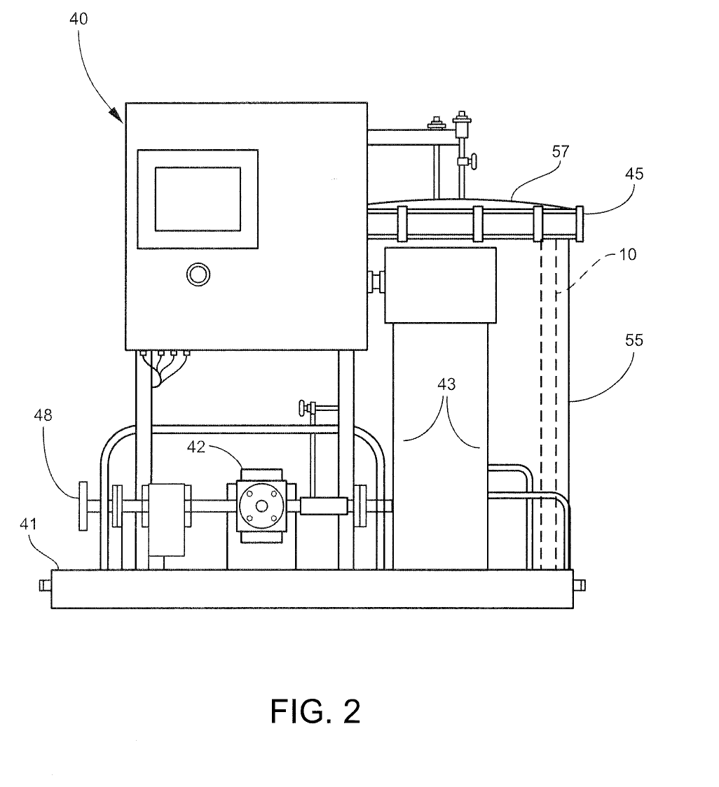

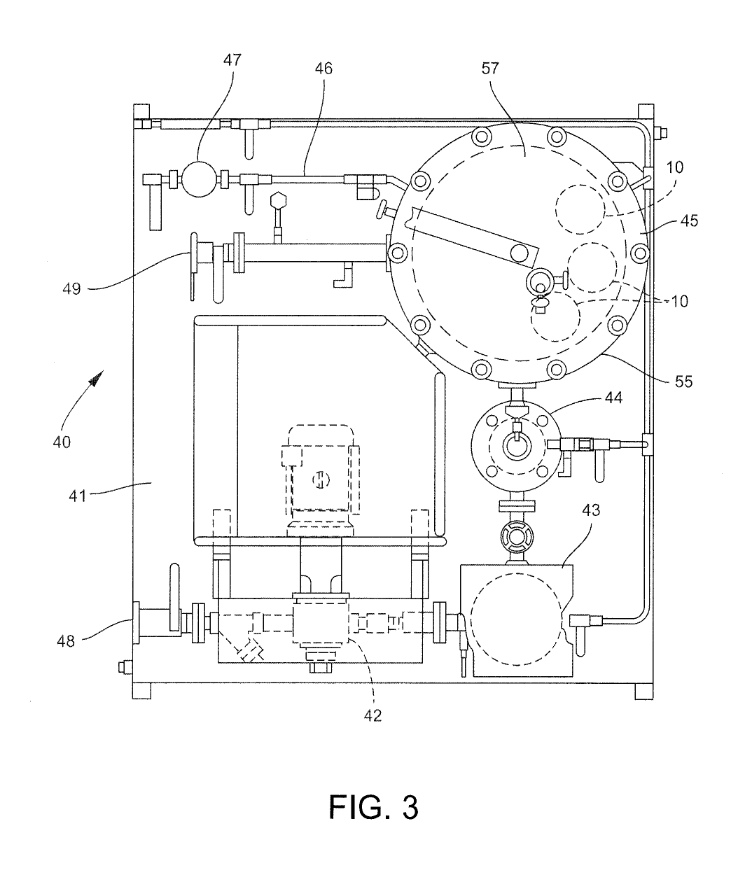

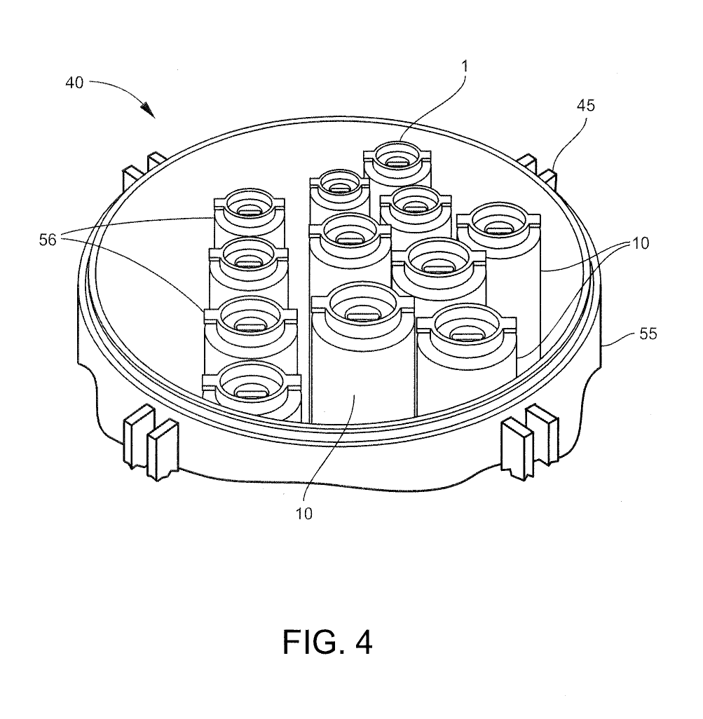

With reference to FIGS. 2-4, assemblies (10) described herein can be used in conjunction with a commercially available filtering machine, such as the oil conditioning system (40) illustrated in FIGS. 2-4, which is manufactured and sold by Kaydon Custom Filtration Corporation under the TURBO-TOC® trade designation. The illustrated organic fluid conditioning apparatus (40) is a self-contained system which is mounted on a drip pan (41), and includes a pump (42), a heater (43), a pre-filter (44), a coalescer (45), a water drainage tube (46) and a water meter (47). In general, the organic fluid, such as a hydrocarbon liquid or other industrial liquid to be filtered, enters through an inlet (48), is pressurized by pump (42), flows through heater (43), pre-filter (44), and coalescer (45), and the conditioned organic fluid flows through an outlet (49) back to the associated machine or equipment (not shown). As best illustrated in FIG. 4, coalescer (45) includes a circular housing or vessel (55) in which a plurality of assemblies (10) having a construction described herein are arranged in a side-by-side relationship. In the illustrated example, vessel (55) also includes a plurality of separator elements (56) per a traditional coalescence-based filtration system design.

However, in some embodiments, an organic fluid conditioning apparatus does not comprise separator elements. Assemblies having a construction described herein can be operable to remove sufficient amounts of water from organic fluids so as to obviate the use of separator elements. In some embodiments, for example, an assembly having a construction described herein can demonstrate a water removal efficiency of greater than 99% or greater than 99.5%. Elimination of separator elements from the organic fluid conditioning apparatus can significantly reduce filtration system costs associated with conditioning organic fluids. Further, the footprint and size of the organic fluid conditioning apparatus can be dramatically reduced, thereby generating advantageous spatial efficiencies.

III. Methods of Removing Water from an Organic Fluid

In a further aspect, methods of removing water from an organic fluid are described herein. A method of removing water from an organic comprises providing an assembly including a coalescer element having interior and exterior surfaces and comprising a porous support tube and a medium positioned within the porous support tube, the medium having a structure for coalescing water droplets in the organic fluid passing through the medium and a separation medium enclosing the exterior surface of the coalescer element and spaced apart from the exterior surface of the coalescer element. The organic fluid is flowed into the interior of the coalescer element and passed through the medium to coalesce contaminant water dispersion in the organic fluid into larger water droplets in the same. The coalesced water droplets in the organic fluid exited from the coalescer element are collected in a barrier region of the separation medium and released from the assembly through a release region in the separation medium. Assemblies used in methods described herein can have any construction and/or properties described in Section I above. For example, an assembly can have a construction as illustrated in FIG. 1 above and operate in a manner as described in FIG. 1.

Further, assemblies used in methods described herein, in some embodiments, demonstrate a water removal efficiency of greater than 99% or greater than 99.5%. High water removal efficiency of assemblies described herein can obviate the need for separator elements downstream of the assemblies in an oil conditioning apparatus, thereby reducing manufacturing and operating costs of the oil conditioning apparatus and generating spatial efficiencies by reducing conditioning apparatus footprint.

IV. Assemblies for Organic Liquid Removal from Water

In another aspect, assemblies for removing organic fluids from water are described herein. For example, an assembly comprises a coalescer element having interior and exterior surfaces and comprising a porous support tube and a medium positioned within the porous support tube, the medium having a structure for coalescing organic liquid droplets in the water passing though the medium. A separation medium encloses the exterior surface of the coalescer element and is spaced apart from the exterior surface of the coalescer element. The separation medium comprises a barrier region for collecting coalesced organic fluid droplets in the water exited from the coalescer element and a release region for releasing organic fluid droplets from the assembly.

In some embodiments, assemblies for removing organic fluids from water can have a general construction and structure as set forth in Section I hereinabove and illustrated in FIG. 1. However, assemblies for removing organic fluids from water draw several important distinctions from the assemblies described in Section I. A principle distinction is evident in the construction of the coalescing medium and separation medium. The coalescing medium can have any structure for coalescing organic liquid droplets in the water passing through the medium. In some embodiments, a coalescing medium is provided a by multilayer pleat block formed of individual pleats arranged side-by-side and formed of an integrated, multilayer material. The individual pleats can be formed of hydrophobic or oleophobic, non-woven filter media. The compositional identity, number and function of the individual layers of the hydrophobic/oleophobic pleat block can vary depending on the desired properties of the multilayer pleat block. In some embodiments, individual layer of the hydrophobic pleat block can have a basis weight described in Section I herein. Additionally, a multilayer pleat block can also include a layer of woven hydrophobic/oleophobic fabric. The layer of woven hydrophobic/oleophobic fabric can exhibit a mesh opening size of 10-50 μm and an open area of 5-30%. In some embodiments, the layer of woven fabric is arranged on the downstream side of the multilayer non-woven filter media of the hydrophobic/oleophobic pleat block.

A multilayer hydrophobic/oloephobic pleat block can employ one or more wire mesh screens as supporting layer(s). In some embodiments, a wire mesh support layer can have a thickness of 5-40 mils with individual wires of the mesh support having diameter of 5-30 mils. In some embodiments, for example, individual fiber layers of the multilayer pleat block are arranged or sandwiched between wire mesh screens. A pleat block can be provided by integrating the individual layers into a single strip and pleating the multilayer strip to integrally join the individual layers. The pleated multilayer strip can be subsequently cut to a predetermined length and formed into a predetermined shape having dimensions for close reception in the interior of the porous support tube. Ends of the strip of pleated material can be joined together to provide a closed structure in the porous support tube.

In addition to the coalescer element, an assembly described herein comprises a separation medium enclosing the exterior surface of the coalescer element and spaced apart from the exterior surface of the coalescer element, the separation medium comprising a barrier region for collecting coalesced organic liquid droplets in the water exited from the coalescer element and a release region for releasing organic fluid droplets from the assembly. The separation medium can have any structural and compositional parameters for collecting coalesced organic liquid droplets in the water exited from the coalescer element and releasing the organic liquid droplets from the assembly. The barrier region of a separation medium, for example, can comprise a hydrophilic or oleophobic fabric or polymeric membrane. A hydrophilic fabric, in some embodiments, is formed of synthetic fibers. Suitable synthetic fibers can comprise hydrophilic fibers or hydrophobic fibers having a surface treatment rendering the hydrophobic fibers sufficiently deficient in affinity for coalescing organic liquid droplets in water. Hydrophilic/oloephobic fabric of the barrier region can be woven demonstrating an open mesh size of 10-100 μM and an open area of 5 to 40%. Woven hydrophilic/oleophobic fabric of the barrier region can have a thickness of 40-100 μm and a basis weight of 0.005 to 0.015 pounds/ft².

The release region of the separation medium can have any structural and compositional parameters for releasing organic liquid droplets collected by the barrier region. In some embodiments, the release region comprises the hydrophilic/oloephobic fabric of the barrier region, wherein the hydrophilic/oleophobic fabric has been provided apertures or perforations of sufficient size to release the collected organic liquid droplets from the assembly. A perforation in the hydrophilic/oloephobic fabric, for example, can have a size of 1-5 mm. Alternatively, the release region is formed of hydrophobic/oleophobic fibers for passing collected organic liquid droplets out of the assembly.

In some embodiments, hydrophobic or oleophobic fabric of the release region and hydrophilic or oleophobic fabric of the barrier region are seamed together to form the separation medium. Further, the barrier and release regions can occupy varying amounts of surface area of the separation medium. For example, a ratio of surface area of barrier region to release region of the separation medium can range from 500:1 to 1:1. Additionally, the release region can be located proximate one or both ends of the coalescer element for facile removal of organic fluid droplets from the assembly.

The separation medium is spaced apart from the exterior surface of the coalescer element providing a space for the organic fluid droplets exiting from the coalescer element to further coalesce among each other and simultaneously move upward to the release region. Coalesced organic liquid droplets in the water exited from the coalescer element are blocked by the barrier region of the separation medium as the water flows through the separation medium. The blocked organic fluid droplets are collected in the space between the separation medium and coalescer element. Very small blocked droplets can attach on the inner surface of the separation medium. These attached organic fluid droplets can merge with organic fluid droplets in the incoming water flow by droplet collision and can release from their attachment sites when sufficiently large size is achieved. Buoyancy force draws the large blocked organic fluid droplets upward in the space between the separation medium and coalescer element.

Furthermore, the blocked droplets wet and reflow over the exterior surface of the coalescer element and coalesce among each other into relatively larger droplets. Buoyancy force draws those enlarged organic liquid droplets to the release region for removal from the assembly. Spacing of the separation medium from the exterior surface of the coalescer element can be set according to several considerations, including flow rate of the water stream through the assembly, organic liquid content of the water at the inlet of the assembly, water temperature and particulate concentration of the water. In some embodiments, the separation medium is spaced from the exterior surface of the coalescer element a distance of 1-50 mm or 5-50 mm.

In being spaced apart from the exterior surface of the coalescer element, the separation medium can be coupled to the coalescer element through end caps of the coalescer element. For example, fabric of the separation medium can be coupled to, tucked under or otherwise held in place by end caps. Securing the fabric of the separation medium with end caps of the coalescer element permits the fabric to be spaced apart from the circumferential/sidewall exterior surface of the coalescer element from which water flows during operation of the assembly.

### V. Water Conditioning Apparatus

Additionally, water conditioning apparatus are also described herein. A water conditioning apparatus comprises a coalescing unit having a housing and a plurality of assemblies for removing organic fluid from the water within the housing, wherein at least one of the assemblies includes a coalescer element having interior and exterior surfaces and comprising a porous support tube and a medium positioned within the porous support tube, the medium having a structure for coalescing organic fluid droplets in the water passing through the medium. A separation medium encloses the exterior surface of the coalescer element and is spaced apart from the exterior surface of the coalescer element, the separation medium comprising a barrier region for collecting coalesced organic fluid droplets in the water exited from the coalescer element and a release region for releasing coalesced organic fluid droplets from the assembly. Further, in some embodiments, the water conditioning apparatus does not include one or more separator elements.

In some embodiments, as water condition apparatus has structure and construction described in Section II herein and illustrated in FIGS. 2-4. Assemblies described in Section IV are employed for removal of organic liquid from the water supplied to the conditioning apparatus.

VI. Methods of Removing Organic Liquids from Water

In a further aspect, methods of removing organic fluid from water are described herein. A method of removing organic fluid from water comprises providing an assembly including a coalescer element having interior and exterior surfaces and comprising a porous support tube and a medium positioned within the porous support tube, the medium having a structure for coalescing organic fluid droplets in the water passing through the medium and a separation medium enclosing the exterior surface of the coalescer element and spaced apart from the exterior surface of the coalescer element. The water is flowed into the interior of the coalescer element and passed through the medium to coalesce organic fluid droplets in the water. The organic fluid droplets in the water exited from the coalescer element are collected in a barrier region of the separation medium and released from the assembly through a release region in the separation medium.

A variety of organic fluids can be removed from water with coalescer elements, apparatus and methods described herein. For example, organic fluids comprise hydrocarbon liquids including oils, fuels, petroleum products, industrial fluids and hydraulic fluids. In some embodiments, coalescer elements, apparatus and methods described herein can be used in water remediation or clean-up of sites polluted by oils, petroleum, fuels and/or other organic liquids.

These and other embodiments are further illustrated in the following non-limiting examples.

### Example 1

### Assembly

An assembly having the design and construction illustrated in FIG. 1 was constructed. The coalescer element had a length of 18 inches and outer diameter of 6 inches. The two pleat blocks of the coalescer element each had the multilayer construction provided in Table I.

TABLE I
Multilayer Pleat Block Construction
Multilayer Pleat Block Construction in Flow
Direction of Hydrocarbon Liquid

| | |
|---|---|
| 1 | Epoxy coated steel wire mesh screen (thickness 5-20 mils) |
| 2 | Microglass media layer (basis wt. 0.015-0.030 lbs/ft², |
| | thickness 10-30 mils) |
| 3 | Glass fiber layer (basis wt. 0.010-0.020 lbs/ft², |
| | thickness (10-30 mils) |
| 4 | Glass fiber layer (basis wt. 0.010-0.020 lbs/ft², |
| | thickness (10-30 mils) |
| 5 | Glass fiber layer (basis wt. 0.010-0.020 lbs/ft², |
| | thickness (10-30 mils) |
| 6 | Glass fiber layer (basis wt. 0.010-0.020 lbs/ft², |
| | thickness (10-30 mils) |
| 7 | Epoxy coated steel wire mesh screen (thickness 5-20 mils) |

Pleat height in each pleat block was 0.65 inches. Pleat numbers of interior and exterior pleat blocks were 30 and 50 respectively. The separation medium of the assembly included a barrier region formed of woven polyester commercially available from SaatiTech. The polyester was provided a hydrophobic surface treatment and had a mesh opening size of 15-20 μm and an open area 10-15%. The separation medium also included a water release region formed of woven polyester. The woven polyester of the water release region demonstrated a construction substantially similar to the polyester fabric of the barrier region, the difference being the polyester fabric of the release region was provided a hydrophilic surface treatment. The water release region of the separation medium was located proximate the base of the assembly.

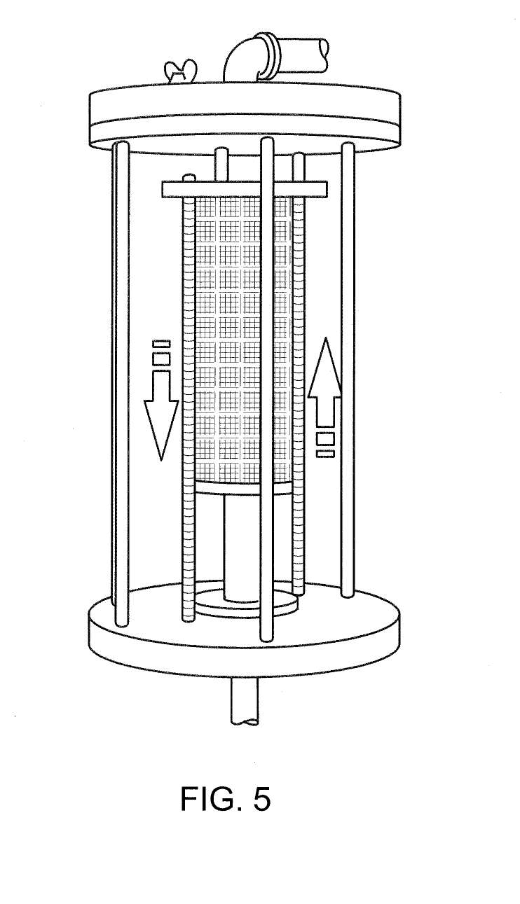

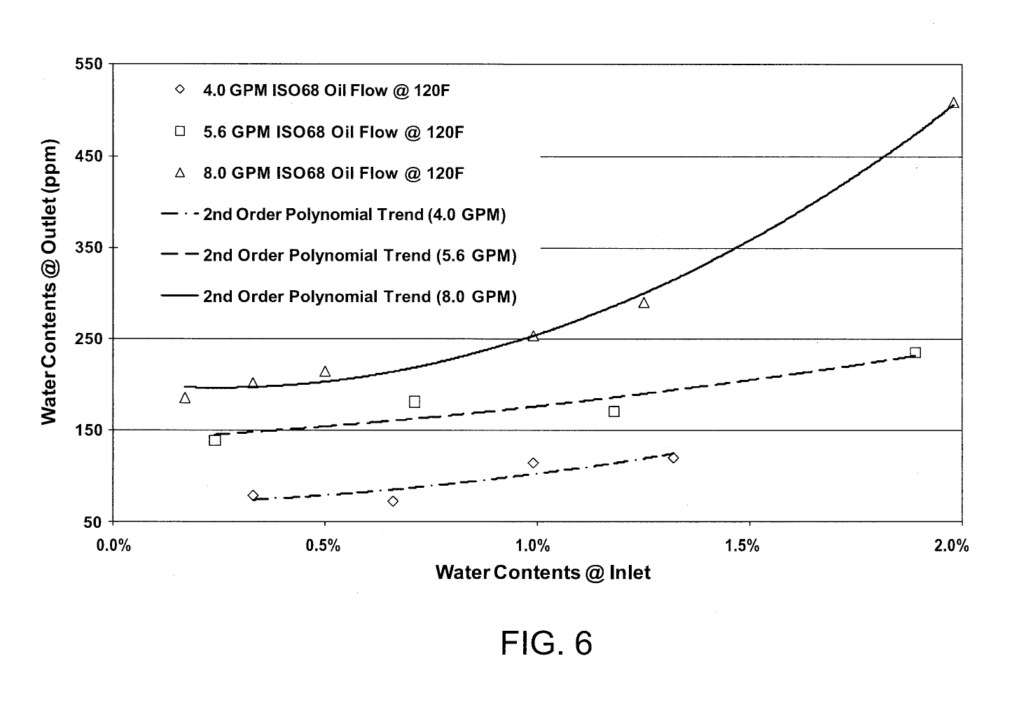

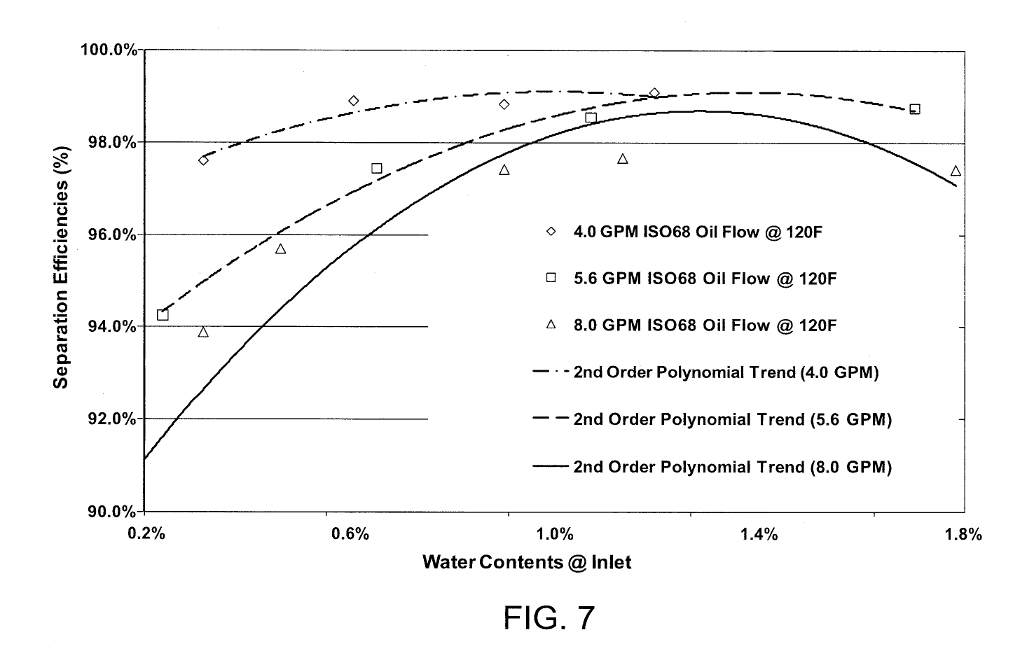

The assembly was tested for efficiency of water removal from a hydrocarbon liquid at flow rates of 4.0 gallons per minute (GPM), 5.6 GPM and 8.0 GPM. The hydrocarbon liquid employed in the test was ISO68 hydraulic oil having water content at the inlet of the testing apparatus varying from 0.2-2%. The temperature of the ISO68 hydraulic oil was 120° F. The apparatus used for assembly testing is illustrated in FIG. 5. The results of the testing are provided in FIGS. 6 and 7. As displayed in FIGS. 6 and 7, the assembly demonstrated efficient removal of water from the ISO68 hydraulic oil over the range of flow rates and inlet water contents. As a technical reference, Standard DIN 51524 recommends the maximum water content in mineral-oil-based hydraulic fluids to be less than 0.05 wt % (500 ppm).

### Example 2

### Assembly

An assembly having a design similar to that illustrated in FIG. 1 was constructed. However, the coalescer element of the assembly employed a single pleat block instead of the two pleat block architecture of FIG. 1. The single pleat block had the construction provided in Table II. The coalescer element had a length of 12 inches and an outer diameter of 4.25 inches.

TABLE II
Multilayer Pleat Block Construction
Multilayer Pleat Block Construction in Flow
Direction of Hydrocarbon Liquid

| | |
|---|---|
| 1 | Epoxy coated steel wire mesh screen (thickness 5-20 mils) |
| 2 | Microglass media layer (basis wt. 0.015-0.030 lbs/ft², |
| | thickness 10-30 mils) |
| 3 | Microglass media layer (basis wt. 0.015-0.030 lbs/ft², |
| | thickness 10-30 mils) |
| 4 | Glass fiber layer (basis wt. 0.010-0.020 lbs/ft², |
| | thickness (10-30 mils) |
| 5 | Glass fiber layer (basis wt. 0.010-0.020 lbs/ft², |
| | thickness (10-30 mils) |
| 6 | Glass fiber layer (basis wt. 0.010-0.020 lbs/ft², |
| | thickness (10-30 mils) |
| 7 | Woven hydrophilic fabric (basis wt. 0.005-0.015 lbs/ft², |
| | mesh opening (10-30 μm) |
| 8 | Epoxy coated steel wire mesh screen (thickness 5-20 mils) |

Pleat height was 0.75 inches and pleat number was 36. The separation medium of the assembly included a barrier region formed of woven polyester commercially available from SaatiTech. The polyester was provided a hydrophobic surface treatment and had a mesh opening size of 15-20 μm and an open area 10-15%. The separation medium also included a water release region formed by 0.05 inch perforations in the woven hydrophobic fabric proximate the base of the assembly.

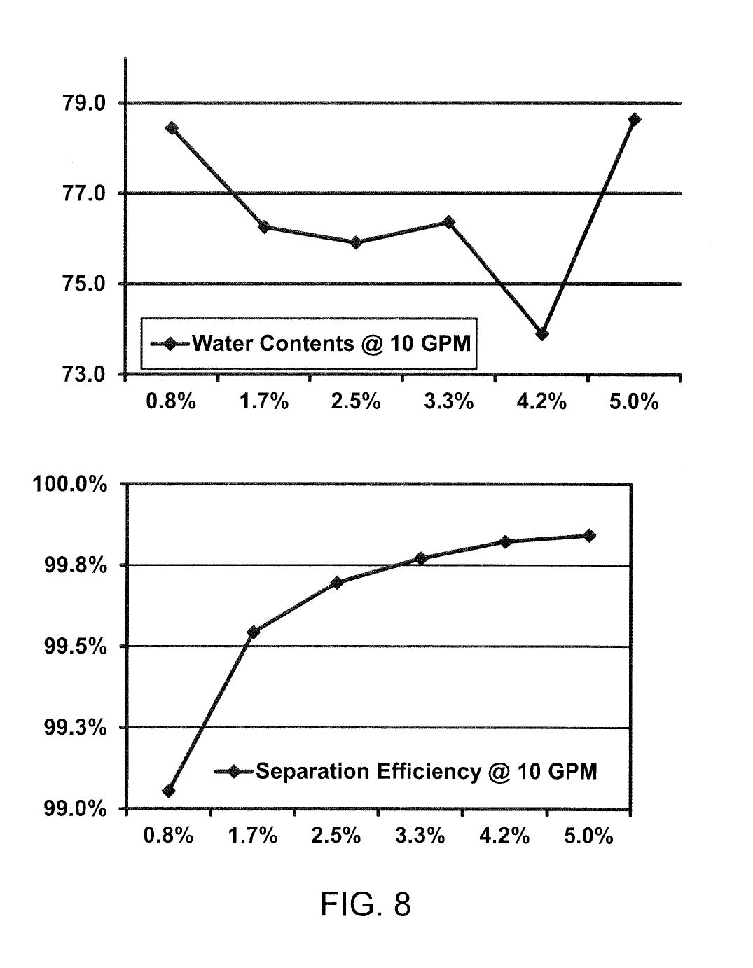

The assembly was tested for efficiency of water removal from a hydrocarbon liquid at a flow rate of 10 GPM. The hydrocarbon liquid employed in the test was No. 2 Diesel Fuel at 60° F. having water content at the inlet of the testing apparatus varying from 0.8-5%. The results of the testing are provided in FIG. 8. As displayed in FIG. 8, the assembly demonstrated water removal efficiency greater than 99% over the range of water inlet values during one single steady-state flow pass through the assembly.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. An assembly for removing water from a hydrocarbon liquid comprising:
a coalescer element having interior and exterior surfaces and comprising a porous support tube and a medium positioned within the porous support tube, the medium having a structure for coalescing water droplets in the hydrocarbon liquid passing through medium; and
a separation medium enclosing the exterior surface of the coalescer element and spaced apart from the exterior surface of the coalescer element, the separation medium comprising a barrier region for collecting coalesced water droplets in the hydrocarbon liquid exited from the coalescer element and a release region for releasing coalesced water droplets from the assembly.

2. The assembly of claim 1, wherein the barrier region of the separation medium comprises a hydrophobic fabric.

3. The apparatus of claim 2, wherein the hydrophobic fabric is woven.

4. The apparatus of claim 2, wherein the hydrophobic fabric is non-woven.

5. The apparatus of claim 2, wherein the hydrophobic fabric has a mesh opening size of 10 to 100 μm.

6. The apparatus of claim 1, wherein the release region comprises a hydrophobic fabric having apertures of sufficient size to release the coalesced water droplets from the assembly.

7. The apparatus of claim 2, wherein the release region comprises a hydrophilic fabric.

8. The apparatus of claim 1, wherein the release region is proximate one or both ends of the coalescer element.

9. The apparatus of claim 1, wherein a ratio of surface area of barrier region to release region of the separation medium ranges from 500:1 to 1:1.

10. The apparatus of claim 1, wherein the structure of the medium positioned within the support tube comprises a first multilayer pleat block.

11. The apparatus of claim 10, wherein the multilayer pleat block layer comprises multiple layers of fibrous coalescing media.

12. The apparatus of claim 11, wherein the multiple layers of fibrous coalescing media are contained by porous support layers.

13. The apparatus of claim 10, wherein the structure of the medium positioned within the support tube comprises a second multilayer pleat block in a concentric arrangement with the first multilayer pleat block.

14. The apparatus of claim 13, wherein the second multilayer pleat block comprises multiple layers of fibrous coalescing media.

15. The apparatus of claim 14, wherein the multiple layers of fibrous coalescing media are contained by porous support layers.

16. The apparatus of claim 2, wherein the separation medium is spaced apart from the exterior surface of the coalescer element a distance of 1 to 50 mm.

17. The apparatus of claim 1, wherein the hydrocarbon liquid is selected from the group consisting of diesel fuel, lubricating oil, synthetic oil, insulating oil and hydraulic fluid.

18. The apparatus of claim 1, wherein the separation medium comprises a hydrophobic polymeric membrane.

19. A hydrocarbon liquid conditioning apparatus comprising:
a coalescing unit having a housing; and
a plurality of assemblies for removing water from the hydrocarbon liquid within the housing, wherein at least one of the assemblies includes a coalescer element having interior and exterior surfaces and comprising a porous support tube and a medium positioned within the porous support tube, the medium having a structure for coalescing water droplets in the hydrocarbon liquid passing through the medium and a separation medium enclosing the exterior surface of the coalescer element and spaced apart from the exterior surface of the support element, the separation medium comprising a barrier region for collecting coalesced water droplets in the hydrocarbon liquid exited from the coalescer element and a release region for releasing coalesced water droplets from the assembly.

20. The hydrocarbon liquid conditioning apparatus of claim 19, wherein the coalescing unit does not include one or more separator elements.
